(19) United States
(12) Patent Application Publication
(10) Pub. No.: US 2022/0289952 A1
(43) Pub. Date: Sep. 15, 2022

(54) POLYMER COMPOSITION, CROSS-LINKED PRODUCT AND TIRE

(71) Applicant: ENEOS MATERIALS CORPORATION, Minato-ku, Tokyo (JP)

(72) Inventor: Masaaki INOUE, Minato-ku (JP)

(73) Assignee: ENEOS MATERIALS CORPORATION, Minato-ku, Tokyo (JP)

(21) Appl. No.: 17/638,589

(22) PCT Filed: Aug. 28, 2020
(86) PCT No.: PCT/JP2020/032664

§ 371 Date: Feb. 25, 2022

(30) Foreign Application Priority Data
Aug. 30, 2019 (JP) 2019-158854

(51) Int. Cl. C08L 15/00; B60C 1/00; B60C 11/00

(52) U.S. Cl. CPC C08L 15/00; B60C 1/0025; B60C 1/0016; B60C 11/0008; C08L 2205/035; C08L 2312/00; B60C 2011/0025

(57) ABSTRACT

A polymer composition includes a polymer (A) having, when composition ratios (molar ratios) of a structural unit represented by formula (1), a structural unit represented by formula (2), a structural unit represented by formula (3), and a structural unit represented by formula (4) in the polymer (A) are p, q, r, and s, respectively, a value α represented by formula (i) of 0.60 or more:

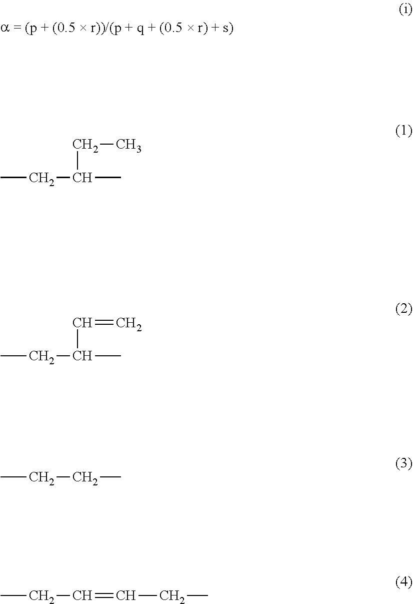

with a weight average molecular weight (Mw) of 1.0×10⁵ to 2.0×10⁶ in terms of polystyrene measured by gel permeation chromatography, and a carbon-carbon unsaturated bond; and a paraffin wax (B) having a melting point of 70° C. or more.

### CROSS-REFERENCE TO RELATED APPLICATIONS

The present application is based on Japanese Patent Application No. 2019-158854, filed on Aug. 30, 2019, the contents of which are incorporated herein by reference in their entirety.

### TECHNICAL FIELD

The present disclosure relates to a polymer composition, a cross-linked product and a tire.

### BACKGROUND ART

Polymers having a carbon-carbon unsaturated bond such as conjugated diene-based polymers have been widely used as rubber material. In particular, conjugated diene-based polymers (for example, styrene-butadiene copolymers) exhibit various good properties such as thermal resistance, wear resistance, mechanical strength, and molding processability, and thus have been widely used in various industrial products such as pneumatic tires, anti-vibration rubber, and hoses. Further, it has been proposed to obtain a cross-linked rubber having high strength and low wear by using a hydrogenated conjugated diene-based polymer in which a part of the unsaturated bonds of the conjugated diene-based polymer is hydrogenated (see, e.g., Patent document 1).

### CITATION LIST

### Patent Document

Patent document 1: WO 2015/064646

### SUMMARY OF INVENTION

### Technical Problem

Although use of a highly saturated diene-based polymer enables to obtain a rubber having a high strength and low wear, there is a concern that the processability of the polymer composition is reduced due to increased crystallinity of the polymer. Accordingly, improvement in processability of the polymer composition is required, while not impairing the strength and the wear resistance of the rubber formed from a highly saturated diene-based polymer.

The present disclosure has been made in view of the problem described above, and a main object of the present disclosure is to provide a polymer composition having excellent processability, while maintaining high strength and high wear resistance of the rubber.

### Solution to Problem

As a result of diligent studies to solve the above-described problem in the prior art, the present discloser has found that inclusion of a highly saturated diene-based polymer and a paraffin wax having a melting point above a predetermined temperature in a polymer composition for producing a rubber can solve the problem. Specifically, the following means are provided by the present disclosure.

[1] A polymer composition including:

a polymer (A) having, when composition ratios (molar ratios) of a structural unit represented by formula (1), a structural unit represented by formula (2), a structural unit represented by formula (3), and a structural unit represented by formula (4) in the polymer (A) are p, q, r, and s, respectively, a value α represented by formula (i) of 0.60 or more:

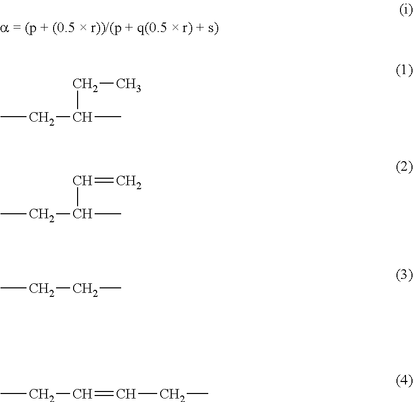

with a weight average molecular weight (Mw) of 1.0×10⁵ to 2.0×10⁶ in terms of polystyrene measured by gel permeation chromatography, and a carbon-carbon unsaturated bond; and

a paraffin wax (B) having a melting point of 70° C. or more.

[2] A cross-linked product produced by using a polymer composition including the above-described polymer (A) and the above-described paraffin wax (B).
[3] A tire having one or both of a tread and a sidewall formed from a polymer composition including the above-described polymer (A) and the above-described paraffin wax (B).

### Advantageous Effects of Invention

According to the present disclosure, a polymer composition including a highly saturated diene-based polymer and a paraffin wax having a melting point of 70° C. or more can have improved processability, while maintaining high strength and high wear resistance of a cross-linked product made from the polymer composition.

### DESCRIPTION OF EMBODIMENTS

The matters relating to the implementation of the present disclosure will be described in detail below.

### <Polymer Composition>

A polymer composition of the present disclosure includes a highly saturated diene-based polymer and a paraffin wax.

### <Highly Saturated Diene-Based Polymer>

The highly saturated diene-based polymer (hereinafter, also referred to as polymer (A)) included in the polymer composition of the present disclosure is a polymer having a carbon-carbon unsaturated bond and can be cross-linked by vulcanization.

When composition ratios (molar ratios) of a structural unit represented by formula (1), a structural unit represented by formula (2), a structural unit represented by formula (3), and a structural unit represented by formula (4) in the polymer (A) are p, q, r, and s, respectively, the polymer has a value α represented by formula (i) of 0.60 or more.

α=(p+(0.5×r))/(p+q+(0.5×r)+s) (i)

The polymer (A) can be produced by a method including, for example, a step of polymerizing a monomer containing butadiene to obtain a conjugated diene-based polymer having an active terminal (polymerization step), and a step of hydrogenating the conjugated diene-based polymer (hydrogenation step). Further, the method may optionally include a step of modifying a terminal of the conjugated diene-based polymer obtained by the polymerization step (modification step). Specifically, the production can be performed by appropriately changing, the molecular weight, the aromatic vinyl compound amount, the vinyl bond content, the hydrogenation ratio, the type of modifier, and the like to match the purpose of use in accordance with the method described in WO 2014/133097. In addition, the production can be also performed by copolymerizing a diene-based monomer such as 1,3-butadiene with a non-conjugated olefin in accordance with the method described in WO 2015/190073. The polymer (A) and a method for producing the polymer (A) will now be described in detail, taking a hydrogenated conjugated diene-based polymer as an example.

### (Polymerization Step)

In the case where the polymer (A) is a hydrogenated conjugated diene-based polymer, the conjugated diene-based polymer before hydrogenation is a polymer having a structural unit derived from a conjugated diene compound, which is preferably a copolymer having a structural unit derived from a conjugated diene compound and a structural unit derived from an aromatic vinyl compound. The present polymerization step is a step of obtaining a conjugated diene-based polymer having an active terminal by polymerizing a monomer containing a conjugated diene compound, preferably a conjugated diene compound and an aromatic vinyl compound.

In the polymerization, as the conjugated diene compound, 1,3-butadiene can be preferably used. Further, in the polymerization, a conjugated diene compound other than 1,3-butadiene may be used in addition to 1,3-butadiene. It is preferable that such a conjugated diene compound be copolymerizable with 1,3-butadiene and an aromatic vinyl compound. Specific examples thereof include isoprene, 2,3-dimethyl-1,3-butadiene, and 1,3-pentadiene. Among these, isoprene is preferable as the conjugated diene compound other than 1,3-butadiene. One type of the conjugated diene compound may be used alone, or two or more types may be used in combination.

Examples of the aromatic vinyl compound include styrene, 2-methylstyrene, 3-methylstyrene, 4-methylstyrene, α-methylstyrene, N,N-dimethylaminoethylstyrene, and diphenylethylene. Among these, the aromatic vinyl compound is particularly preferably one or more compounds selected from styrene and α-methylstyrene. One type of the aromatic vinyl compound can be used alone, or two or more types may be used in combination.

The conjugated diene-based polymer obtained by the present polymerization step may be a homopolymer of a conjugated diene compound or a copolymer of a conjugated diene compound and an aromatic vinyl compound. From the viewpoint of obtaining a cross-linked product having a high strength, a copolymer of a conjugated diene compound and an aromatic vinyl compound is preferred. Alternatively, the copolymer may be a polymer obtained by using 1,3-butadiene and a conjugated diene compound other than 1,3-butadine. In particular, it is preferable that the conjugated diene-based polymer be a copolymer of 1,3-butadiene and styrene from the viewpoint of having high living properties in anionic polymerization.

In the copolymer of the conjugated diene compound and the aromatic vinyl compound, from the viewpoint of improving the low hysteresis loss properties of a cross-linked rubber, the amount of the aromatic vinyl compound used is preferably 10 to 50% by mass with respect to the total amount of the monomers used for the polymerization. By keeping the content of the aromatic vinyl compound within the above range, both productivity and strength can be achieved. The amount of the aromatic vinyl compound used is more preferably 15% by mass or more, with respect to the total amount of the monomers used for the polymerization. The amount of the aromatic vinyl compound used is more preferably 45% by mass or less, and further preferably 40% by mass or less, with respect to the total amount of the monomers used for the polymerization.

It is preferable that the monomers used in the production of the conjugated diene-based polymer before hydrogenation include 50 to 90 parts by mass of butadiene, 10 to 50 parts by mass of an aromatic vinyl compound, and 0 to 40 parts by mass of a conjugated diene compound other than butadiene with respect to 100 parts by mass of the total amount of the monomers used in the polymerization. Using such contents is preferable in terms of achieving both the productivity and strength of the cross-linked rubber.

Any of the conjugated diene compounds and the aromatic vinyl compounds mentioned as examples above has the same action that enables to obtain a conjugated diene-based polymer having an active terminal. Therefore, even those compounds not described in the following Examples may be used in this disclosure.

In the polymerization, monomers other than the conjugated diene-based compounds and the aromatic vinyl compounds may be used. Examples of the other monomers include acrylonitrile, methyl (meth)acrylate, and ethyl (meth)acrylate. The amount of other monomers used with respect to the total amount of monomers used in polymerization is preferably 40% by mass or less, more preferably 30% by mass of less, and still more preferably 20% by mass or less.

As the polymerization method for obtaining the conjugated diene-based polymer according to the present disclosure, any of a solution polymerization method, a gas phase polymerization method, and a bulk polymerization method may be used, and the solution polymerization method is particularly preferred. Further, as the polymerization type, any of a batch type or a continuous type may be used. In the case of using the solution polymerization method, specific examples of the polymerization method include a method of polymerizing a monomer containing a conjugated diene compound in an organic solvent in the presence of a polymerization initiator and a randomizer used on an as needed basis.

As the polymerization initiator, it is preferable that at least one of an alkali metal compound and an alkali earth metal compound be used. As the alkali metal compound and the alkali earth metal compound, one usually used as an initiator of anionic polymerization may be used. Specific examples thereof include an alkyllithium such as methyllithium, ethyllithium, n-propyllithium, n-butyllithium, sec-butyllithium, and t-butyllithium; 1,4-dilithiobutane, phenyllithium, stilbenelithium, naphthyllithium, naphthylsodium, naphthylpotassium, di-n-butylmagnesium, di-n-hexylmagnesium, ethoxypotassium, and calcium stearate. Of these, a lithium compound is preferred.

Further, the polymerization reaction may be carried out in the presence of a compound (hereinafter, also referred to as compound (R)) obtained by mixing at least any of the above-described alkali metal compounds and alkali earth metal compounds with a compound having a functional group that interacts with silica (hereinafter, also referred to as compound (C1)). By carrying out the polymerization in the presence of the compound (R), a functional group having interaction with silica can be introduced into the polymerization initiation terminal of the conjugated diene-based polymer. As used herein, the term “interaction” means that a covalent bond is formed between molecules, or an intermolecular force (e.g., an intermolecular electromagnetic force such as ion-dipole interaction, dipole-dipole interaction, a hydrogen bond, and Van der Waals force) that is weaker than a covalent bond is formed. Further, the phrase “functional group having interaction with silica” means a group having at least one atom that interacts with silica, such as a nitrogen atom, a sulfur atom, a phosphorus atom, and an oxygen atom.

The compound (R) is preferably a reaction product of a lithium compound such as alkyllithium and a nitrogen-containing compound (secondary amine compound or the like). Specific examples of the nitrogen-containing compound include dimethylamine, diethylamine, dipropylamine, dibutylamine, dodecamethyleneimine, N,N′-dimethyl-N′-trimethylsilyl-1,6-diaminohexane, piperidine, pyrrolidine, hexamethyleneimine, heptamethyleneimine, dicyclohexylamine, N-methylbenzylamine, di-(2-ethylhexyl)amine, diallylamine, morpholine, N-(trimethylsilyl)piperazine, N-(tert-butyldimethylsilyl)piperazine, and 1,3-ditrimethylsilyl-1,3,5-triazinane. In the case of carrying out the polymerization in the presence of the compound (R), the compound (R) may be prepared by mixing an alkali metal compound or an alkali earth metal compound with the compound (C1) in advance, and the polymerization may be carried out by adding the prepared compound (R) to the polymerization system. Alternatively, the polymerization may be carried out by adding an alkali metal compound or an alkali earth metal compound and the compound (C1) to the polymerization system and mixing them in the polymerization system to prepare the compound (R).

The randomizer may be used to adjust a vinyl content (i.e., the amount of 1,2-vinyl bonds). Examples of the randomizer include dimethoxybenzene, tetrahydrofuran, dimethoxyethane, diethylene glycol dibutyl ether, diethylene glycol dimethyl ether, 2,2-di(tetrahydrofuryl)propane, 2-(2-ethoxyethoxy)-2-methylpropane, triethylamine, pyridine, N-methylmorpholine, and tetramethylethylenediamine. One type of the randomizer may be used alone, or two or more types may be used in combination.

The organic solvent used for polymerization may be an organic solvent that is inert to the reaction. For example, aliphatic hydrocarbons, alicyclic hydrocarbons, and aromatic hydrocarbons can be used. Of these, the organic solvent is preferably a hydrocarbon having 3 to 8 carbon atoms. Specific examples of the hydrocarbon having 3 to 8 carbon atoms include n-pentane, isopentane, n-hexane, cyclohexane, propene, 1-butene, isobutene, trans-2-butene, cis-2-butene, 1-pentyne, 2-pentyne, 1-hexene, 2-hexene, benzene, toluene, xylene, ethylbenzene, heptane, cyclopentane, methylcyclopentane, methylcyclohexane, 1-pentene, 2-pentene, and cyclohexene. These organic solvents may be used either alone or in combination of two or more.

When using the solution polymerization method, the monomer concentration in the reaction solvent is preferably 5 to 50% by mass, and more preferably 10 to 30% by mass, since such a monomer concentration enables a balance to be maintained between productivity and polymerization controllability. The polymerization reaction temperature is preferably −20° C. to 150° C., more preferably 0 to 120° C., and particularly preferably 20 to 100° C. It is preferable to carry out the polymerization reaction under a pressure sufficient to substantially maintain the monomer to be in a liquid phase. Such a pressure may be achieved by a method for pressurizing the inside of the reaction vessel using gas that is inert to the polymerization reaction.

The vinyl content of the conjugated diene-based polymer obtained by the above polymerization is preferably 5 to 70% by mass, more preferably 10 to 60% by mass, and further preferably 15 to 50% by mass. The vinyl content less than 5% by mass tends to decrease the grip properties, and the vinyl content more than 70% by mass tends to deteriorate wear resistance. The vinyl content is a value measured by a ¹H-NMR.

It is preferable that the conjugated diene-based polymer before hydrogenation of the present disclosure be a random copolymer of a structural unit derived from a conjugated diene compound and a structural unit derived from an aromatic vinyl compound. In this case, the dispersibility of filler can be favorably improved. Incidentally, the random copolymer may have a block portion made of a conjugated diene compound at one terminal or both terminals.

### <Modification Step>

The modification step is a step of reacting the active terminal of the conjugated diene-based polymer obtained in the above polymerization step with a compound having a functional group that interacts with silica (hereinafter, also referred to as compound (C2)). By the step, the functional group having an interaction with silica can be introduced into the polymerization termination terminal of the conjugated diene-based polymer. In the present specification, the active terminal means a portion other than the structure derived from a monomer having a carbon-carbon double bond (more specifically, a metal terminal), which is present at an end of the molecular chain.

The conjugated diene-based polymer used in the modification reaction (hereinafter, also referred to as terminal modification reaction) in the present step may have an unmodified or modified polymerization initiation terminal as long as it has an active terminal. The compound (C2) is not particularly limited as long as it is a compound capable of reacting with the active terminal of the conjugated diene-based polymer. It is preferable that the compound have one or more functional groups selected from the group consisting of an amino group, a group having a carbon-nitrogen double bond, a nitrogen-containing heterocyclic group, a phosphino group, an epoxy group, a thioepoxy group, a protected hydroxy group, a protected thiol group and a hydrocarbyloxysilyl group, capable of reacting with a polymerization active terminal. Specifically, as the compound (C2), at least one selected from the group consisting of a compound represented by formula (9), a compound represented by formula (10), a compound represented by formula (11), and a compound represented by formula (12) may be preferably used.

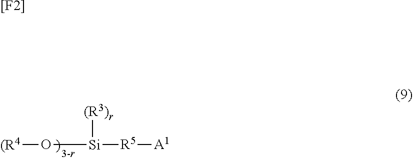

wherein, A¹ is a monovalent functional group having at least one atom selected from the group consisting of nitrogen, phosphorus, oxygen, sulfur and silicon, and bonding to R⁵ through a nitrogen atom, a phosphorus atom, an oxygen atom, a sulfur atom, a silicon atom or a carbon atom in a carbonyl group, or a (thio)epoxy group; R³ and R⁴ are each independently a hydrocarbyl group; and R⁵ is a hydrocarbylene group, and r is an integer of 0 to 2; in the case where a plurality of R³ are present, the plurality of R³ are the same group or different groups; in the case where a plurality of R⁴ are present, the plurality of R⁴ are the same group or different groups.

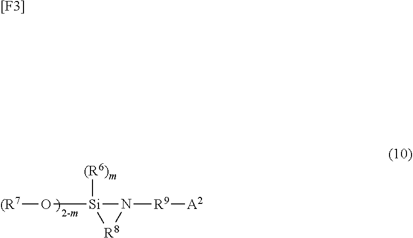

wherein, A² is a monovalent functional group having at least one atom selected from the group consisting of nitrogen, phosphorus, oxygen, sulfur and silicon, having no active hydrogen, and bonding to R⁹ through a nitrogen atom, a phosphorus atom, an oxygen atom, a sulfur atom, or a silicon atom, or a hydrocarbyl group having 1 to 20 carbon atoms; R⁶ and R⁷ are each independently a hydrocarbyl group; R⁸ is a hydrocarbylene group, R⁹ is a single bond or a hydrocarbylene group and m is 0 or 1; in the case where a plurality of R⁷ are present, the plurality of R⁷ are the same group or different groups.

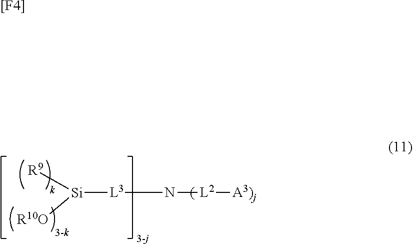

wherein A³ represents a monovalent group bonding to L² through an imino group, an amido group, a(thio)carbonyl group, a (thio)carbonyloxy group, a sulfide group or a polysulfide group, or a protected primary amino group, a protected secondary amino group, a tertiary amino group, a nitrile group, a pyridyl group, a (thio)epoxy group, a (thio)isocyanate group, a (thio)formyl group, a (thio)carboxylic acid ester group, a metal salt of (thio)carboxylic acid ester group, —COX¹ (X¹: a halogen atom), an imidazolyl group, or a group represented by formula (11a); L² and L³ are each independently a single bond or a hydrocarbylene group having 1 to 20 carbon atoms, and R⁹ and R¹⁰ are each independently a hydrocarbyl group; k is an integer of 0 to 2, and j is 0 or 1; in the case where a plurality of identical symbols are present in the formula for each of the symbols R⁹, R¹⁰ and L³, the groups represented by the symbols are the same or different groups from each other; in the case where a plurality of k are present in the formula, the plurality of k are the same number or different numbers.

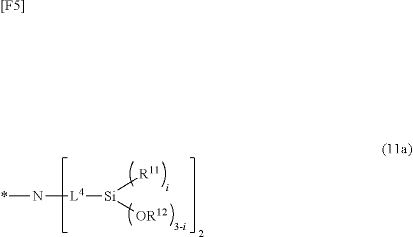

wherein L⁴ is a single bond or a hydrocarbylene group having 1 to 20 carbon atoms, and R¹¹ and R¹² are each independently a hydrocarbyl group; i is an integer of 0 to 3; “*” indicates a site that binds to L²; For each of the symbols R¹¹, R¹² and L⁴, the groups represented by the symbols are the same group or different group from each other; a plurality of i in the formula are the same number or different numbers.

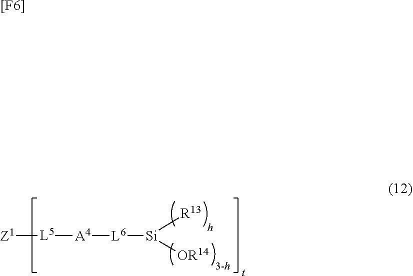

wherein A⁴ is an imino group, an amido group, a (thio)carbonyl group or a (thio)carbonyloxy group, Z¹ is a t-valent group having or not having a nitrogen atom and having 1 to 20 carbon atoms, L⁵ is a single bond or a hydrocarbylene group having 1 to 20 carbon atoms, L⁶ is a hydrocarbylene group having 1 to 20 carbon atoms, and R¹³ and R¹⁴ are each independently a hydrocarbyl group; h is 0 or 1, and t is 2 or 3; for each of the symbols R¹⁴, L⁵, L⁶ and A⁴, the groups represented by the symbols are the same group or different groups from each other; the plurality of h in the formula are the same number or different numbers.

In the above formulas (9) and (10), it is preferable that the hydrocarbyl group of R³, R⁴, R⁶, R⁷ and A² be a linear or branched alkyl group having 1 to 20 carbon atoms, a cycloalkyl group having 3 to 20 carbon atoms, or an aryl group having 6 to 20 carbon atoms.

It is preferable that the hydrocarbylene group of R⁵ and R⁹ be a linear or branched alkanediyl group having 1 to 20 carbon atoms, a cycloalkylene group having 3 to 20 carbon atoms, or an arylene group having 6 to 20 carbon atoms.

From the viewpoint of enhancing the reactivity with the conjugated diene-based polymer, it is preferable that r and m be 0 or 1.

In the case where A¹ is the above monovalent functional group, it is preferable that at least one atom selected from the group consisting of nitrogen, phosphorus, oxygen, sulfur and silicon possessed by A¹, and at least one atom selected from the group consisting of nitrogen, phosphorus, oxygen, sulfur and silicon possessed by A² be not bonded to an active hydrogen and be protected by a protecting group (e.g., trisubstituted hydrocarbylsilyl group). In the present specification, the active hydrogen means a hydrogen atom bonded to an atom other than a carbon atom, and preferably has a lower bond energy than the carbon-hydrogen bond of polymethylene. The protecting group is a functional group that converts A¹ and A² into a functional group that is inactive to a polymerization active terminal. The (thio)epoxy group includes an epoxy group and a thioepoxy group.

A¹ may be a group that can be turned into an onium ion by an onium salt producing agent. Since the compound (C2) has such a group (A¹), excellent shape retention can be imparted to the hydrogenated conjugated diene-based polymer. Specific examples of A¹ include a nitrogen-containing group with two hydrogen atoms of a primary amino group substituted by two protecting groups, a nitrogen-containing group with one hydrogen atom of a secondary amino group substituted by one protecting group, a phosphorus-containing group with two hydrogen atoms of a tertiary amino group, an imino group, a pyridyl group, or a primary phosphino group substituted by two protecting groups, a phosphorus-containing group with one hydrogen atom of a secondary phosphino group substituted by one protecting group, a group with a hydrogen atom of a tertiary phosphino group, an epoxy group, or a hydroxy group protected by a protecting group, a sulfur-containing group with a hydrogen atom of a thioepoxy group or a thiol group substituted by a protecting group, and a hydrocarbyl oxycarbonyl group. Among these, a group having a nitrogen atom is preferred from the viewpoint of good affinity with silica, and a nitrogen-containing group with two hydrogen atoms of a tertiary amino group or a primary amino group substituted with two protecting groups is more preferred.

In the above formula (11), examples of the hydrocarbylene group having 1 to 20 carbon atoms of L² and L³ include a linear or branched alkanediyl group having 1 to 20 carbon atoms, a cycloalkylene group having 3 to 20 carbon atoms, and an arylene group having 6 to 20 carbon atoms. Examples of the hydrocarbyl group of R⁹ and R¹⁰ include a linear or branched alkyl group having 1 to 4 carbon atoms and a cycloalkyl group having 3 or 4 carbon atoms. The (thio)carbonyl group includes a carbonyl group and a thiocarbonyl group, the (thio)carbonyloxy group includes a carbonyloxy group and a thiocarbonyloxy group, the (thio)isocyanate group includes an isocyanate group and a thioisocyanate group, the (thio)formyl group includes a formyl group and a thioformyl group, and the (thio)carboxylic acid ester group includes a carboxylic acid ester group and a thiocarboxylic acid ester group.

In the above formula (12), Z¹ is a divalent or trivalent group having 1 to 20 carbon atoms which may have a nitrogen atom, and preferably has a nitrogen atom. Examples of the hydrocarbylene group of L⁵ having 1 to 20 carbon atoms and the hydrocarbylene group of L⁶ having 1 to 20 carbon atoms include a linear or branched alkanediyl group having 1 to 20 carbon atoms, a cycloalkylene group having 3 to 20 carbon atoms, and an arylene group having 6 to 20 carbon atoms. Examples of the hydrocarbyl group of R¹³ and R¹⁴ include a linear or branched alkyl group having 1 to 4 carbon atoms and a cycloalkyl group having 3 or 4 carbon atoms.

As preferred specific examples of the compound (C2), examples of the compound represented by the above formula (9) include N,N-bis(trimethylsilyl)aminopropyl trimethoxysilane, N,N-bis(trimethylsilyl)aminopropyl methyl diethoxysilane, N,N′,N′-tris(trimethylsilyl)-N-(2-aminoethyl)-3-aminopropyltriethoxysilane, 3-(4-trimethylsilyl-1-piperazino)propylmethyl dimethoxysilane, 3-glycidoxypropylmethyldimethoxysilane, and 3-glycidoxypropyltriethoxysilane; examples of the compound represented by the above formula (10) include 2,2-dimethoxy-1-(3-trimethoxysilylpropyl)-1,2-azacilolidine, 2,2-diethoxy-1-(3-trimethoxysilylpropyl)-1,2-azasiloridine, 2,2-dimethoxy-1-phenyl-1,2-azasiloridine, 1-trimethylsilyl-2,2-dimethoxy-1-aza-2-silacyclopentane, 2,2-dimethoxy-8-(4-methylpiperazinyl)methyl-1,6-dioxa-2-silacyclooctane, and 2-(2,2-dimethoxy-1,2-azasiloridine-1-yl)-N,N-diethylethane-1-amine; examples of the compound represented by the above formula (11) include N,N-bis(trimethoxysilylpropyl)aminopropyl-3-(1-imidazole), N,N-bis(triethoxysilylpropyl)aminopropyl-3-(1-imidazole), N,N-bis(trimethoxysilylpropyl)aminopropylmethyl diethylsilane, N,N,N-tris(triethoxysilylpropyl)amine, and N,N,N′,N′-tetrakis(3-triethoxysilylpropyl)-1,3-diaminopropane; and examples of the compound represented by the above formula (12) include the following formulas (M-1) to (M-4):

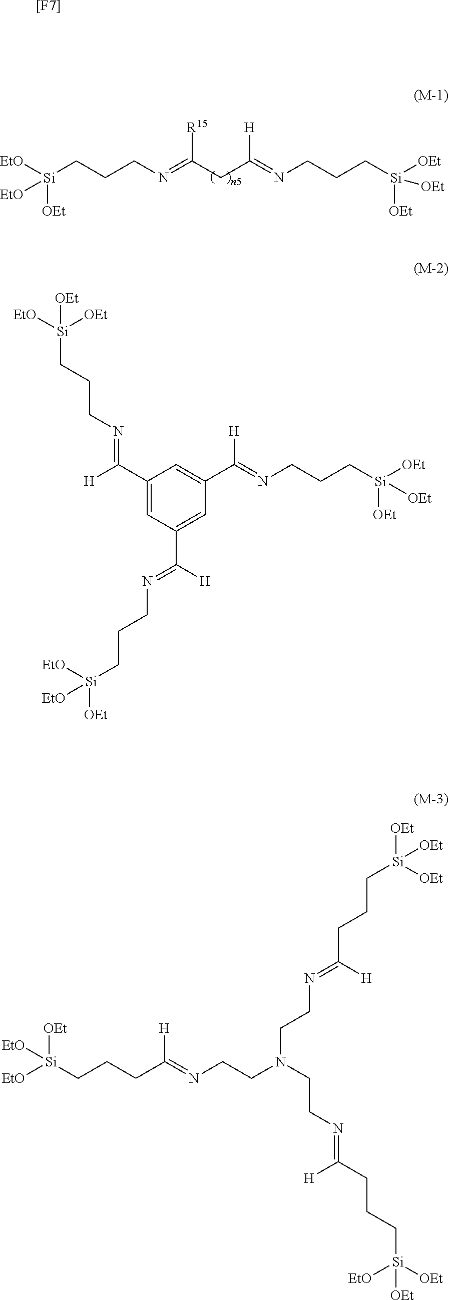

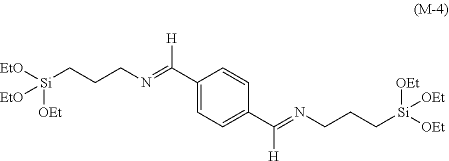 [SMILES: CCO[Si](CCC/N=C/c1ccc(/C=N/CCC[Si](OCC)(OCC)OCC)cc1)(OCC)OCC]

wherein in formula (M-1), R¹⁵ represents a hydrogen atom or an alkyl group having 1 to 20 carbon atoms, and n5 is an integer of 1 to 10.

One type of the compound (C2) may be used alone, or two or more types may be used in combination.

The above-mentioned terminal modification reaction can be carried out as, for example, a solution reaction. This solution reaction may be carried out using a solution including an unreacted monomer after the completion of the polymerization reaction in the polymerization step, and may also be carried out after the conjugated diene-based polymer included in the solution is isolated and dissolved in an appropriate solvent such as cyclohexane. Further, the terminal modification reaction may be carried out as either a batch type or a continuous type. On this occasion, the method of adding the compound (C2) is not particularly limited, and examples thereof include a method of adding the compound (C2) all at once, a method of dividedly adding the compound (C2), and a method of continuously adding the compound (C2).

The amount of the compound (C2) to be used in the terminal modification reaction may be appropriately set according to the type of the compound used in the reaction, being preferably 0.1 molar equivalents or more, and more preferably 0.3 molar equivalents or more, with respect to the metal atom of the polymerization initiator involved in the polymerization reaction. By setting the amount of the compound (C2) used to 0.1 molar equivalents or more, the modification reaction can be sufficiently promoted, and the dispersibility of the silica can be suitably improved.

The temperature of the terminal modification reaction is usually the same as the temperature of the polymerization reaction, preferably −20 to 150° C., more preferably 0 to 120° C., and particularly preferably 20 to 100° C. In the case where the temperature of the modification reaction is low, the viscosity of the modified conjugated diene-based polymer tends to increase. On the other hand, in the case where the temperature of the modification reaction is high, the polymerization active terminal tends to be deactivated. The reaction time of the modification reaction is preferably 1 minute to 5 hours, more preferably 2 minutes to 1 hour. In order to control the Mooney viscosity of the polymer in the terminal modification reaction, silicon tetrachloride, an epoxy-containing compound (for example, tetraglycidyl-1,3-bisaminomethylcyclohexane), etc. may be used together with the compound (C2).

### <Hydrogenation Step>

The hydrogenated conjugated diene-based polymer of the present disclosure can be obtained by hydrogenating the above-obtained modified or unmodified conjugated diene-based polymer. The hydrogenation reaction can be performed by any methods under any conditions, so long as a conjugated diene-based polymer having the desired hydrogenation ratio is obtained. Examples of those hydrogenation methods include a method involving the use of a catalyst containing an organometallic compound of titanium as a main component of a hydrogenation catalyst; a method involving the use of a catalyst containing an organic compound of iron, nickel, or cobalt and an organometallic compound such as an alkylaluminum; a method involving the use of an organic complex of an organometallic compound of, for example, ruthenium or rhodium; and a method involving the use of a catalyst including a carrier (e.g., carbon, silica, or alumina) on which a metal such as palladium, platinum, ruthenium, cobalt, or nickel is supported, and the like. Among the various methods, a method in which hydrogenation is carried out under mild conditions of low pressure and low temperature conditions using an organometallic compound of titanium alone, or a uniform catalyst composed of an organometallic compound of titanium and an organometallic compound of lithium, magnesium, and aluminum (JP 63-4841 A and JP 1-37970 A) is industrially preferable, hydrogenation selectivity for the double bond of butadiene is also high, and is suitable for the purpose of the present disclosure.

The hydrogenation of the modified conjugated diene-based polymer is carried out using a solvent that is inert to the catalyst and in which the conjugated diene-based polymer is soluble. Preferred solvents include aliphatic hydrocarbons such as n-pentane, n-hexane, and n-octane, alicyclic hydrocarbons such as cyclohexane and cycloheptane, aromatic hydrocarbons such as benzene and toluene, and ethers such as diethyl ether and tetrahydrofuran, which are used alone or as a mixture in which these solvents are a main component.

The hydrogenation reaction is generally carried out by holding the conjugated diene-based polymer at a predetermined temperature under a hydrogen or an inert atmosphere, adding a hydrogenation catalyst under stirring or non-stirring, and then increasing the pressure to a predetermined pressure by introducing hydrogen gas. The term “inert atmosphere” means an atmosphere that does not react with the substances involved in the hydrogenation reaction, and examples thereof include helium, neon, and argon. Air and oxygen are not preferable because they oxidize the catalyst and cause the catalyst to be deactivated. In addition, nitrogen is not preferable because it acts as a catalytic poison during the hydrogenation reaction and reduces the hydrogenation activity. In particular, it is most preferable that the hydrogenation reaction vessel has an atmosphere of hydrogen gas alone.

The hydrogenation reaction process for obtaining a hydrogenated conjugated diene-based polymer can be a batch process, a continuous process, or a combination thereof. When a titanocene diaryl compound is used as the hydrogenation catalyst, the titanocene diaryl compound may be added alone to the reaction solution as is, or may be added as a solution in an inert organic solvent. As the inert organic solvent used when the catalyst is used as a solution, various solvents that do not react with the substances involved in the hydrogenation reaction can be used. The inert organic solvent is preferably the same solvent as the solvent used for the hydrogenation reaction. An added amount of the catalyst is 0.02 to 20 mmol per 100 g of conjugated diene-based polymer before hydrogenation.

The hydrogenated conjugated diene-based polymer in the present disclosure has a value α represented by the following formula (i) of 0.60 or more.

α=(p+(0.5×r))/(p+q+(0.5×r)+s) (i)

With α controlled to 0.60 or more, a cross-linked rubber having high strength and excellent wear resistance can be obtained. For this reason, α is preferably 0.65 or more, more preferably 0.75 or more, still more preferably 0.80 or more, and particularly preferably 0.85 or more. Also, α is preferably 0.99 or less. Incidentally, p, q, r and s are as described above.

The value α defined by the above formula (i) corresponds to the hydrogenation ratio of the hydrogenated conjugated diene-based polymer. For example, when α is 0.60, the hydrogenation ratio of the hydrogenated conjugated diene-based polymer is 60%. The hydrogenation ratio of the hydrogenated conjugated diene-based polymer can be adjusted based on the duration of the hydrogenation reaction and the like. The hydrogenation ratio can be measured by a ¹H-NMR. When the polymer (A) is a polymer obtained by copolymerizing a diene monomer and a non-conjugated olefin, the value of a can be adjusted by changing the ratio of the monomers to be copolymerized.

In a preferable method of obtaining the hydrogenated conjugated diene-based polymer of the present disclosure, a monomer including butadiene is subjected to solution polymerization in the presence of an alkali metal compound, the modification step is carried out using the obtained polymer solution as it is, and then the hydrogenation step is carried out. Such a method is industrially useful. In this case, the hydrogenated conjugated diene-based polymer is isolated from the obtained solution through removal of the solvent therefrom. The polymer can be isolated by a known desolvation method, such as steam stripping, and then performing a drying operation, such as a heat treatment.

From the viewpoint of obtaining a vulcanized rubber more excellent in low fuel consumption performance, the polymer (A) preferably has one or more functional groups selected from the group consisting of an amino group, a nitrogen-containing heterocyclic group, a phosphino group, a hydroxyl group, a thiol group and a hydrocarbyloxysilyl group, and more preferably has one or more functional groups selected from the group consisting of an amino group, a nitrogen-containing heterocyclic group and a hydrocarbyloxysilyl group. It is particularly preferable that these functional groups be introduced into one end or both ends of the polymer (A) from the viewpoint of further enhancing the effect of improving the low fuel consumption performance.

The polymer (A) has a weight average molecular weight (Mw) of 1.0×10⁵ to 2.0×10⁶. The Mw less than 1.0×10⁵ tends to decrease the wear resistance and low fuel consumption performance of the vulcanized rubber made from the polymer composition containing the polymer (A), and the Mw more than 2.0×10⁶ tends to deteriorate the processability. The Mw is preferably 1.2×10⁵ or more, more preferably 1.5×10⁵ or more. The Mw is preferably 1.5×10⁶ or less, more preferably 1.0×10⁶ or less. The range of the Mw is preferably 1.0×10⁵ to 1.5×10⁶, more preferably 1.2×10⁵ to 1.5×10⁶, and still more preferably 1.5×10⁵ to 1.0×10⁶. As used herein, the weight average molecular weight is a value in terms of polystyrene measured by gel permeation chromatography (GPC).

### <Paraffin Wax>

The polymer composition of the present disclosure includes a paraffin wax having a melting point of 70° C. or more (hereinafter, also referred to as paraffin wax (B)). By including the paraffin wax (B) together with the polymer (A) in the polymer composition, the processability of the polymer composition during kneading can be improved. Further, a film of paraffin wax (B) is formed on the surface of a vulcanized product (for example, a tire) made from the polymer composition, which is suitable because the ozone resistance of the vulcanized product can be improved.

The melting point of the paraffin wax (B) is preferably 72° C. or more, more preferably 75° C. or more, and still more preferably 79° C. or more in that it can provide a higher effect of improving the processability of the polymer composition during kneading. Further, the melting point of the paraffin wax (B) is preferably 140° C. or less, more preferably 130° C. or less, and still more preferably 125° C. or less, in order to suppress a reduction in processability of the polymer composition. On the other hand, with a melting point of the paraffin wax used in combination with the polymer (A) of less than 70° C., the effect of improving the processability of the polymer composition is insufficient. The melting point of paraffin wax is a value measured in accordance with JIS K2235: 1991, 5.3.

The paraffin wax (B) may contain at least one of a branched saturated hydrocarbon (isoparaffin) and a saturated cyclic hydrocarbon (cycloparaffin) in addition to a linear saturated hydrocarbon (normal paraffin) as long as the melting point is 70° C. or more. Further, the paraffin wax (B) may contain microcrystalline wax having a relatively high content of isoparaffin or cycloparaffin. The proportion of the microcrystalline wax in the paraffin wax (B) is preferably 50% by mass or more, more preferably 60% by mass or more, with respect to the total amount of the microcrystalline wax (B).

The paraffin wax (B) is usually paraffinic hydrocarbons having 35 or more carbon atoms. The number of carbon atoms in the paraffin wax (B) is preferably 85 or less, more preferably 80 or less, from the viewpoint of suppressing a decrease in processability of the polymer composition and a decrease in rubber elasticity of the vulcanized product by addition of the paraffin wax (B). The paraffin wax (B) may contain paraffinic hydrocarbons having 45 or more carbon atoms. The proportion of the paraffinic hydrocarbons having 45 or more carbon atoms in the paraffin wax (B) is preferably 10% by mass or more, more preferably 20% by mass or more, with respect to the total amount of the paraffin wax (B).

Specific examples of the paraffin wax (B) include commercially available paraffin waxes such as Hi-Mic-1045 (melting point: 72° C.), Hi-Mic-2065 (melting point: 75° C.), Hi-Mic-1070 (melting point: 80° C.), Hi-Mic-1080 (melting point: 84° C.), Hi-Mic-1090 (melting point: 88° C.), and Hi-Mic-2095 (melting point: 101° C.), (all of the above manufactured by Nippon Seiro Co., Ltd.); and Suntight SW (manufactured by Seiko Chemical Co., Ltd., melting point: 100 to 120° C.). One type of the paraffin wax (B) may be used alone, or two or more types may be used in combination.

The content of the paraffin wax (B) in 100 parts by mass of rubber components (i.e. total amount of the polymer (A) and other rubber components) contained in the polymer composition is preferably 0.5 parts by mass or more, more preferably 1.0 parts by mass or more, and still more preferably 1.1 parts by mass or more, from the viewpoint of sufficiently obtaining the effect of improving the processability during kneading of the polymer composition. Further, the content of the paraffin wax (B) in 100 parts by mass of rubber components contained in the polymer composition is preferably 5 parts by mass or less, more preferably 2.5 parts by mass or less, and still more preferably 2 parts by mass or less, in order to maintain good rubber elasticity.

Although the details of the mechanism for improving the processability of the polymer composition during kneading by including the paraffin wax (B) together with the polymer (A) in the polymer composition are not clear, it is presumed that the paraffin wax having a melting point above a predetermined temperature disrupts the crystallinity of the polymer (A) to improve the processability of the polymer composition.

Cross-Linking Agent

A cross-linked product according to this embodiment is formed by heat treatment. The type of the cross-linking agent included in the polymer composition to perform the heat treatment is not particularly limited. Specific examples of the cross-linking agent include organic peroxides, phenol resins, sulfur, sulfur compounds, p-quinones, derivatives of p-quinone dioximes, bismaleimide compounds, epoxy compounds, silane compounds, amino resins, polyols, polyamines, triazine compounds, and metal soaps. Of these, at least one selected from the group consisting of organic peroxides, phenol resins, and sulfur is preferable. One type of the cross-linking agent may be used alone, or two or more types may be used in combination.

Examples of the organic peroxide include 1,3-bis(t-butylperoxyisopropyl)benzene, 2,5-dimethyl-2,5-bis(t-butylperoxy)hexyne-3, 2,5-dimethyl-2,5-bis(t-butylperoxy)hexene-3, 2,5-dimethyl-2,5-bis(t-butylperoxy)hexane, 2,2′-bis(t-butylperoxy)-p-isopropylbenzene, dicumyl peroxide, di-t-butyl peroxide, and t-butyl peroxide.

Examples of the phenolic resin include p-substituted phenolic compounds represented by formula (8), o-substituted phenol-aldehyde condensates, m-substituted phenol-aldehyde condensates, and brominated alkylphenol-aldehyde condensates. Of these, p-substituted phenolic compounds are preferred.

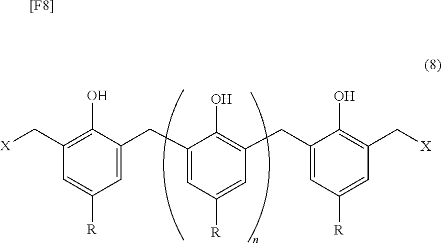

In formula (8), X represents a hydroxyl group, a halogenated alkyl group, or a halogen atom; R represents a C1 to C15 monovalent saturated hydrocarbon group; and n is an integer of 0 to 10. The p-substituted phenolic compound can be prepared through condensation reaction between p-substituted phenol and an aldehyde (preferably formaldehyde) in the presence of an alkali catalyst.

Examples of commercially available phenolic resins include product name “Tackirol 201” (alkylphenol-formaldehyde resin, manufactured by Taoka Chemical Company, Limited), product name “Tackirol 250-I” (brominated alkylphenol-formaldehyde resin (percent bromination: 4%), manufactured by Taoka Chemical Company, Limited), product name “Tackirol 250-III” (brominated alkylphenol-formaldehyde resin, manufactured by Taoka Chemical Company, Limited), product name “PR-4507” (manufactured by Gun Ei Chemical Industry Co., Ltd.), product name “ST137X” (manufactured by Rohm & Haas Company), product name “Sumilite Resin PR-22193” (manufactured by Sumitomo Durez Co., Ltd.), product name “Tamanol 531” (manufactured by Arakawa Chemical Industries, Ltd.), product name “SP1059,” product name “SP1045,” product name “SP1055,” and product name “SP1056” (manufactured by Schenectady), and product name “CRM-0803” (manufactured by Showa Union Gosei Co., Ltd.). Of these, “Tackirol 201” is preferably used.

The amount of the crosslinking agent is preferably 0.01 to 20 parts by mass, more preferably 0.1 to 15 parts by mass, still more preferably 0.5 to 10 parts by mass, With respect to 100 parts by mass of the total amount of the rubber components contained in the polymer composition. As used herein, the term “rubber component” included in the polymer composition means a polymer capable of obtaining a cured product that exhibits rubber elasticity by thermosetting. At room temperature, the cured product exhibits properties of undergoing a large deformation by a small force (for example, a two-fold deformation or more when stretched at room temperature), and rapidly returning to almost its original shape when the force is removed.

In the case of using an organic peroxide as cross-linking agent, the amount of the organic peroxide used is preferably 0.05 to 10 parts by mass, more preferably 0.1 to 5 parts by mass, with respect to 100 parts by mass of the total rubber components contained in the polymer composition. With an amount of the organic peroxide for use set to 10 parts by mass or less, the degree of cross-linking can be appropriately increased, so that the mechanical properties of the cross-linked product can be further improved. Also, it is preferable that the amount of the organic peroxide for use be set to 0.05 parts by mass or more, because the degree of cross-linking can be sufficiently increased, so that the rubber elasticity and mechanical strength of the cross-linked product can be further improved.

In the case of using a phenol resin as cross-linking agent, the amount of the phenol resin used is preferably 0.2 to 10 parts by mass, more preferably 0.5 to 5 parts by mass, with respect to 100 parts by mass of the total rubber components contained in the polymer composition. With an amount of the phenol resin for use set to 10 parts by mass or less, the molding processability tends to be sufficiently ensured. On the other hand, with an amount of the phenol resin for use set to 0.2 or more, the degree of cross-linking can be sufficiently increased, so that the rubber elasticity and mechanical strength of the cross-linked product can be ensured.

In the case of using sulfur as cross-linking agent, the amount of sulfur used is preferably 0.1 to 5 parts by mass, more preferably 0.5 to 3 parts by mass, with respect to 100 parts by mass of the total rubber components contained in the polymer composition.

Use of at least one of a cross-linking aid and a cross-linking accelerator together with the cross-linking agent is preferred, because the cross-linking reaction can be carried out gently to form a uniform cross-linking. In the case of using an organic peroxide as cross-linking agent, use of the following as cross-linking aid is preferred: sulfur, a sulfur compound (powdered sulfur, colloidal sulfur, precipitated sulfur, insoluble sulfur, surface-treated sulfur, dipentamethylene thiuram tetrasulfide, etc.), an oxime compound (p-quinone oxime, p,p′-dibenzoyl quinone oxime, etc.), polyfunctional monomers (ethylene glycol di(meth)acrylate, diethylene glycol di(meth)acrylate, triethylene glycol di(meth)acrylate, tetraethylene glycol di(meth)acrylate, polyethylene glycol di(meth)acrylate, trimethylol propane tri(meth)acrylate, diallyl phthalate, tetraallyl oxyethane, triallyl cyanurate, N,N′-m-phenylene bismaleimide, N,N′-m-toluylene bismaleimide, maleic anhydride, divinylbenzene, zinc di(meth)acrylate, etc.). In particular, p,p′-dibenzoyl quinone oxime, N,N′-m-phenylene bismaleimide, and divinylbenzene are preferred. One type of these may be used alone, or two or more types may be used in combination. Incidentally, since N,N′-m-phenylene bismaleimide exhibits an action as cross-linking agent, it may be also used alone as cross-linking agent.

In the case of using an organic peroxide as cross-linking agent, the amount of the cross-linking aid used is preferably 10 parts by mass or less, more preferably 0.2 to 5 parts by mass, with respect to 100 parts by mass of the total rubber components contained in the polymer composition. With an amount of the cross-linking aid for use set to 10 parts by mass or less, the degree of cross-linking can be appropriately increased, so that the molding processability tends to be sufficiently ensured.

In the case of using a phenol resin as cross-linking agent, use of a metal halide (stannous chloride, ferric chloride, etc.), an organic halide (chlorinated polypropylene, butyl bromide rubber, chloroprene rubber, etc.), etc. as cross-linking accelerator is preferred, because the cross-linking rate can be adjusted. Further, it is more preferred to use a dispersant including a metal oxide such as zinc oxide and stearic acid in addition to the cross-linking accelerator.

The polymer composition of the present disclosure may contain, in addition to the polymer (A), a rubber component different from the polymer (A) (hereinafter, also referred to as “other rubber component”) as long as the effect of the present disclosure is not impaired. The type of such other rubber component is not particularly limited, and examples thereof may include butadiene rubber (BR; for example, high-cis BR having 90% or more of cis-1,4 bonds, syndiotactic-1,2-polybutadiene (SPB)—containing BR, and the like), styrene butadiene rubber (SBR), natural rubber (NR), isoprene rubber (IR), styrene isoprene copolymer rubber, butadiene isoprene copolymer rubber, and the like. More preferably, other rubber component is at least one selected from the group consisting of NR, BR, and SBR. The blending ratio of other rubber component is preferably 50 parts by mass or less, and more preferably 30 parts by mass or less, with respect to 100 parts by mass of the total amount of the rubber components (polymer (A) and other rubber components) contained in the polymer composition.

The polymer composition of the present disclosure may contain a resin component together with the rubber component. The type of the resin component is not particularly limited, and examples thereof include polyolefin resins such as polyethylene and polypropylene. In the case where the polymer composition contains the resin component, the blending ratio of the resin component is preferably 1 to 50 parts by mass, and more preferably 5 to 40 parts by mass, with respect to 100 parts by mass of the total amount of the rubber component contained in the polymer composition.

In the polymer composition of the present disclosure, various reinforcing fillers such as carbon black, silica, clay, and calcium carbonate may be used as filler. Preferably, carbon black, silica, or a combination of carbon black and silica is used. Silica is preferred from the viewpoint of static to dynamic ratio, and carbon black is preferred from the viewpoint of the strength of the cross-linked product. Examples of silica include wet silica (hydrous silicic acid), dry silica (silicic anhydride), and colloidal silica, and in particular, wet silica is preferred. Examples of carbon black include furnace black, acetylene black, thermal black, channel black, and graphite, and in particular, furnace black is preferred.

The amount of the filler to be added may be appropriately determined according to the purpose of use, being, for example, 5 to 150 parts by mass with respect to 100 parts by mass of the rubber component included in the polymer composition. The total amount of silica and carbon black in the polymer composition is preferably 20 to 130 parts by mass, more preferably 25 to 110 parts by mass, with respect to 100 parts by mass of the total amount of the rubber components contained in the polymer composition.

In addition to the above-described component, the polymer composition of the present disclosure may also contain various additives generally used in polymer compositions for obtaining vulcanized rubber for various purposes, such as for tires, hoses, anti-vibration, and belts. Examples of these additives include an antioxidant, zinc oxide, stearic acid, a softening agent, sulfur, and a vulcanization accelerator. The blending ratios of these components can be appropriately selected depending on the type of additive as long as the effect of the present disclosure is not impaired.

### <Cross-Linked Product and Tire>

### <Crosslinking Step>

When producing a rubber molded product by using the polymer composition of the present disclosure, usually, the polymer composition is molded into a predetermined shape and then subjected to a crosslinking treatment. The rubber molded product can be produced according to a conventional method. For example, in the production of a tire, the above-described polymer composition is mixed using a mixing machine such as a roll or a mixer, and molded into a predetermined shape. The obtained molded body is placed on an outer side according to a conventional method, vulcanized and molded to form one or both of the tread and the sidewall, thereby obtaining a pneumatic tire. When the rubber molded product is produced, the above-described cross-linking agent and cross-linking aid may be used.

The cross-linked product described above has high strength and excellent processability as well as excellent wear resistance, fuel consumption and ozone resistance. It can be therefore applied to various rubber molded products. Specifically, it can be used as material for tire treads and sidewalls; anti-vibration rubbers for industrial machinery, equipment, etc.; diaphragms, rolls, and various hoses such as radiator hoses and air hoses as well as hose covers; seals such as packing, gaskets, weather strips, O-rings and oil seals; belts such as power transmission belts; and linings, dust boots, etc. Among them, the cross-linked product is suitably used as a tire member, an anti-vibration member, and a belt member, and more suitably used as a tire member.

### EXAMPLES

The present disclosure is specifically described with reference to examples as follows, though the present disclosure is not limited to these examples. Unless otherwise specified, the word “part(s)” and the symbol “%” described in the examples and comparative examples refer to “part(s) by mass” and “% by mass”, respectively. The methods for measuring the various physical property values are shown as follows.

[Weight average molecular weight of polymer]: Determined in terms of polystyrene from the retention time corresponding to the apex of the maximum peak of a GPC curve obtained by gel permeation chromatography (GPC) (HLC-8120GPC (product name (manufactured by Tosoh Corporation))).

### (Gpc Conditions)

Columns: 2 columns, product name “GMHXL” (manufactured by Tosoh Corporation)

Column temperature: 40° C.

Mobile phase: tetrahydrofuran

Flow rate: 1.0 ml/min

Sample concentration: 10 mg/20 ml

[Hydrogenation ratio (%)] and [α]:

Determined by ¹H-NMR at 500 MHz.

### <Production of Highly Saturated Diene-Based Polymer>

### Production Example 1: Synthesis of Catalyst A

A 1-L volume three-necked flask equipped with a stirrer and a dropping funnel was purged with dry nitrogen, and charged with 200 ml of anhydrous tetrahydrofuran and 0.2 mol of tetrahydrofurfuryl alcohol. Then, an n-butyllithium/cyclohexane solution (0.2 mol) was added dropwise to the three-necked flask at 15° C. to carry out a reaction so as to obtain a tetrahydrofuran solution of tetrahydrofurfuryloxylithium.

Next, a 1-L volume three-necked flask equipped with a stirrer and a dropping funnel was purged with dry nitrogen, and charged with 49.8 g (0.2 mol) of bis(η5-cyclopentadienyl)titanium dichloride and 250 ml of anhydrous tetrahydrofuran. Then, the tetrahydrofuran solution of tetrafurfuryloxylithium obtained by the method described above was added dropwise for about 1 hour while stirring at room temperature. After about 2 hours, a reddish brown liquid was removed by filtration and the insoluble portion was washed with dichloromethane.

Then, the solvent in the filtrate and in the washing solution was removed under reduced pressure to obtain a catalyst A [bis(η5-cyclopentadienyl)titanium (tetrahydrofurfuryloxy)chloride] (also referred to as “[chlorobis(2,4-cyclopentadienyl)titanium(IV) tetrahydrofurfuryl alkoxide]”). The yield was 95%.

### Production Example 2: Synthesis of Hydrogenated Conjugated Diene-Based Polymer A

An autoclave reaction vessel having an internal volume of 10 liters was purged with nitrogen and charged with 5000 g of cyclohexane, 150 g of tetrahydrofuran, 250 g of styrene, and 730 g of 1,3-butadiene. The temperature of the contents in the reaction vessel was adjusted to 10° C., and then a cyclohexane solution including n-butyllithium (11.6 mmol) was added to initiate polymerization. The polymerization was carried out under adiabatic conditions, and the maximum temperature reached 85° C.

When the polymerization conversion rate reached 99%, 20 g of butadiene was added, and polymerization was carried out for further 1 minute. Then, 0.09 g of silicon tetrachloride was added for further reaction for 5 minutes. Subsequently, to the obtained reaction solution, 8.5 g of N,N-bis(trimethylsilyl)aminopropylmethyldiethoxysilane was then added, and the reaction was carried out for 30 minutes.

Subsequently, the temperature of the reaction solution was controlled at 80° C. or more, and the hydrogen was introduced into the system. Then, 0.32 g or the catalyst A and 0.39 g of tetrachlorosilane were added thereto. The reaction was carried out for 55 minutes, such that the hydrogen pressure was kept at 1.0 MPa. After the reaction, the reaction solution returned to normal temperature and normal pressure was pulled out from the reaction vessel, so that a polymer solution was obtained.

Next, an aqueous solution (temperature: 80° C.) adjusted to pH 8.5 (pH at 80° C. according to a glass electrode method) with ammonia, which is a pH adjuster, was placed in a desolvation tank. The above polymer solution was further added thereto (in a ratio of 200 parts by mass of the aqueous solution to 100 parts by mass of the polymer solution), and desolvation was performed by steam stripping (steam temperature: 190° C.) for 2 hours at a temperature of the liquid phase of the desolvation tank of 95° C. Drying was then carried out using a heat roll adjusted to 110° C. to obtain a hydrogenated conjugated diene-based polymer A. The weight average molecular weight Mw of the hydrogenated conjugated diene-based polymer A was 28×10⁴, and the degree of hydrogenation was 91% (α=0.91).

### Production Example 3: Synthesis of Hydrogenated Conjugated Diene-Based Polymer S

An autoclave reaction vessel having an internal volume of 5 liters was purged with nitrogen and charged with 2750 g of cyclohexane, 50 g of tetrahydrofuran, 125 g of styrene, and 365 g of 1,3-butadiene. The temperature of the contents in the reaction vessel was adjusted to 10° C., and then a cyclohexane solution including n-butyllithium (5.80 mmol) was added to initiate polymerization. The polymerization was carried out under adiabatic conditions, and the maximum temperature reached 85° C.

When the polymerization conversion rate reached 99%, 10 g of butadiene was added, and polymerization was carried out for further 1 minutes. To the obtained reaction solution, 4.25 g of N,N-bis(trimethylsilyl)aminopropylmethyldiethoxysilane was then added, and the reaction was carried out for 30 minutes. To the resulting polymer solution, 2.0 g of 2,6-di-tert-butyl-p-cresol was added. Subsequently, the solvent was removed by steam stripping using hot water adjusted to pH=9 with sodium hydroxide, and the rubber was dried with a heat roll adjusted to 110° C. to obtain a hydrogenated conjugated diene-based polymer S. The weight average molecular weight Mw of the hydrogenated conjugated diene-based polymer S was 29×10⁴. Incidentally, the hydrogenated conjugated diene-based polymer S has α=0.

### <Production of Polymer Composition and Evaluation of Properties Thereof>

### Examples 1 to 5 and Comparative Examples 1 to 3

Using a plastomill (internal capacity: 250 cc) equipped with a temperature control device, a first stage of kneading was carried out by kneading the hydrogenated conjugated diene-based polymer A, the conjugated diene-based polymer S, natural rubber, silica, carbon black, paraffin wax, a silane coupling agent, stearic acid, an antioxidant, and zinc oxide according to the formulations of the following Table 1 under conditions at a filling rate of 72% and a rotation speed of 60 rpm, so as to obtain compounds. Subsequently, as a second stage of kneading, after cooling the compounds obtained above to room temperature, sulfur and a vulcanization accelerator were added thereto, and the resultants were kneaded. The kneaded products were molded, and vulcanized at 160° C. for a predetermined time with a vulcanization press. The following properties (1) to (5) were evaluated.

### (1) Mooney Viscosity (MV)

In accordance with JIS K6300-1: 2013, a kneaded product before vulcanization as measurement sample was subjected to measurement using an L rotor under conditions with a preheating time of 1 minute, a rotor operating time of 4 minutes, and a temperature of 100° C. An index value of 100 corresponds to the level in Comparative Example 1, and the larger the value, the better the processability of the polymer composition.

### (2) Tensile Test

From the vulcanized rubber sheet as measurement sample, a No. 3 dumbbell type test piece was prepared in accordance with JIS K6251: 2010, and a 100% elongation modulus (M100) was measured. An index value of 100 corresponds to the level in Comparative Example 1, and the larger the value, the higher the strength.

### (3) Wear Resistance

The vulcanized rubber as measurement sample was subjected to measurement in accordance with JIS K 6264-2: 2005 using a DIN wear tester (manufactured by Toyo Seiki Seisaku-sho, Ltd.), at 25° C. with a load of 10 N. An index value of 100 corresponds to the level in Comparative Example 1, and the larger the value, the better the wear resistance.

### (4) Ozone Resistance Test

A test piece prepared from the vulcanized rubber as measurement sample (length: 60 mm, width: 10 mm, thickness: 2.0 mm) was attached to an extension jig in accordance with JIS K6259-1: 2015, subjected to a tensile strain of 20%, and left standing in an ozone concentration of 0.5 ppm for 48 hours to perform a static ozone deterioration test (atmosphere temperature 40° C.) The sample after the test was observed and evaluated according to the following.

### <Evaluation Based on Crack Size>

0: No cracks are present.

1: Cracks that cannot be seen with naked eye but can be observed when enlarged are present.

2: Very small cracks of 0.5 mm or less that can be seen with naked eye are present.

3: Cracks larger than those in the above 2 are present.

### <Evaluation by Crack Density>

S: Cracks are present at a very low density.

F: Cracks are present at a relatively low density.

N: Cracks are present at a higher density than F.

In Table 1, for example, notation “1S” indicates that the size of the cracks is evaluated as “1”, and the density of cracks is evaluated as “S”.

### (5) Low Fuel Consumption (70° C. Tan δ)

The vulcanized rubber as measurement sample was subjected to measurement using ARES-RDA (manufactured by TA Instruments) under conditions with a shear strain of 1.0% and an angular velocity of 100 radians per second at 70° C. An index value of 100 corresponds to the level in Comparative Example 1, and the larger the value, the better the rolling resistance (low fuel consumption performance) with smaller energy loss.

The results of property evaluations in Examples 1 to 5 and Comparative Examples 1 to 3 are shown in Table 1.

TABLE 1

| | | | | | Comparative | Comparative | | Comparative |
|---|---|---|---|---|---|---|---|---|
| | Example 1 | Example 2 | Example 3 | Example 4 | Example 1 | Example 2 | Example 5 | Example 3 |
| <Formulation (phr)> | | | | | | | | |
| Rubber component: | | | | | | | | |
| Hydrogenated SBR (polymer A) | 60 | 60 | 60 | 60 | 60 | 60 | 80 | 80 |
| SBR (polymer S) | 20 | 20 | 20 | 20 | 20 | 20 | — | — |
| NR | 20 | 20 | 20 | 20 | 20 | 20 | 20 | 20 |
| Other components: | | | | | | | | |
| Silica | 70 | 70 | 70 | 70 | 70 | 70 | 70 | 70 |
| Carbon black | 5 | 5 | 5 | 5 | 5 | 5 | 5 | 5 |
| Suntight SW | 2 | — | — | 5 | — | — | 2 | — |
| Hi-Mic-1090 | — | 2 | — | — | — | — | — | — |
| Hi-Mic-1070 | — | — | 2 | — | — | — | — | — |
| Sunknock | — | — | — | — | 2 | — | — | — |
| Silane coupling agent | 3.6 | 3.6 | 3.6 | 3.6 | 3.6 | 3.6 | 3.6 | 3.6 |
| Stearic acid | 2 | 2 | 2 | 2 | 2 | 2 | 2 | 2 |
| Antioxidant | 1 | 1 | 1 | 1 | 1 | 1 | 1 | 1 |
| Zinc oxide | 3 | 3 | 3 | 3 | 3 | 3 | 3 | 3 |
| Vulcanization acceleraror CZ | 1.8 | 1.8 | 1.8 | 1.8 | 1.8 | 1.8 | 1.8 | 1.8 |
| Vulcanization acceleraror D | 1.5 | 1.5 | 1.5 | 1.5 | 1.5 | 1.5 | 1.5 | 1.5 |
| Sulfur | 1.5 | 1.5 | 1.5 | 1.5 | 1.5 | 1.5 | 1.5 | 1.5 |
| <Evaluation of properties> | | | | | | | | |
| MV | 109 | 114 | 115 | 120 | 100 | 95 | 105 | 93 |
| M100 | 113 | 110 | 109 | 110 | 100 | 98 | 121 | 117 |
| Wear resistance | 112 | 110 | 110 | 115 | 100 | 100 | 120 | 111 |
| Ozone resistance | 1S | 1S | 0 | 0 | 0 | 2F | 0 | 1S |
| 70° C. tanδ | 102 | 102 | 103 | 99 | 100 | 100 | 100 | 101 |

Details of each of the components used in Table 1 are as follows.

NR: natural rubber (RSS No. 3)

Silica: Nipsil AQ manufactured by Tosoh Silica Corporation

Carbon black: Dia Black N339 manufactured by Mitsubishi Chemical Corporation

Suntight SW: paraffin wax manufactured by Seiko Chemical Co., Ltd. (melting point: 100 to 120° C.)

Hi-Mic-1090: paraffin wax manufactured by Nippon Seiro Co., Ltd. (melting point: 88° C.)

Hi-Mic-1070: paraffin wax manufactured by Nippon Seiro Co., Ltd. (melting point: 80° C.)

Sunknock: Paraffin wax manufactured by Ouchi Shinko Chemical Industrial Co., Ltd. (melting point: 65° C.)

Silane coupling agent: Si69 manufactured by Evonik Industries

Antioxidant: Nocrack 810NA manufactured by Ouchi Shinko Chemical Industrial Co., Ltd.

Vulcanization accelerator CZ: Noxeller CZ manufactured by Ouchi Shinko Chemical industrial Co., Ltd.

Vulcanization accelerator D: Noxeller D manufactured by Ouchi Shinko Chemical Industrial Co., Ltd.

In Table 1, “-” indicates that the compound in the corresponding column was not used.

As shown in Table 1, the polymer compositions containing the highly saturated diene-based polymer and a paraffin wax having a melting point of 70° C. or more (Examples 1 to 4) had more excellent processability with a higher Mooney viscosity (index) in comparison with the composition in Comparative Example 2 having the same composition as in Examples 1 to 4 except that no paraffin wax was contained. Further, according to the polymer compositions in Examples 1 to 4, vulcanized rubbers exhibiting excellent wear resistance and wear resistance were obtained in comparison with Comparative Example 2. Further, the vulcanized rubbers made from the polymer compositions in Examples 1 to 4 were also excellent in ozone resistance and low fuel consumption.

On the other hand, in Comparative Example 1 to which a paraffin wax having a melting point of 65° C. was added instead of the paraffin waxes having a melting point of 70° C. or more in Examples 1 to 4, the processability of the polymer composition, and the tension strength and wear resistance of the vulcanized rubber were inferior to those in Examples 1 to 4.

Further, in Example 5 to which the polymer S was not added, the processability of the polymer composition was inferior to that in Comparative Example 3 having the same composition as in Example 5 except that no paraffin wax was contained. Further, the vulcanized rubber in Example 5 was also excellent in the tensile strength, wear resistance and ozone resistance in comparison with Comparative Example 3.

From the above results, it has been found that the polymer composition containing a highly saturated diene-based polymer and a paraffin wax having a melting point of a predetermined value or more is excellent in processability, while maintaining good tensile strength, wear resistance and low fuel consumption of the vulcanized rubber.

1-8. (canceled)

9. A polymer composition comprising:
a paraffin wax (B) having a melting point of 75° C. or more; and
a polymer (A), which is a random copolymer and having a value α represented by formula (i) of 0.60 or more:
α=(p+(0.5×r))/(p+q+(0.5×r)+s) (i)
wherein p is a molar composition ratio of a structural unit of formula (1) 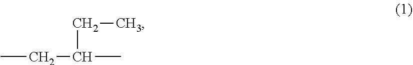
in the polymer (A),
q is a molar composition ratio of a structural unit of formula (2) 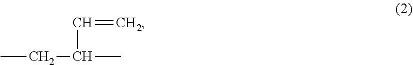
in the polymer (A),
r is a molar composition ratio of a structural unit of formula (3)
—CH₂—CH₂— (3),
in the polymer (A), and
s is a molar composition ratio of a structural unit of formula (4)
—CH₂—CH═CH—CH₂— (4),
in the polymer (A),
wherein the polymer (A) has a weight average molecular weight (Mw) of 1.0×10⁵ to 2.0×10⁶ in terms of polystyrene measured by gel permeation chromatography, and
wherein the polymer (A) comprises a carbon-carbon unsaturated bond.

10. The composition of claim 9, wherein the polymer (A) has one or more functional groups selected from the group consisting of an amino group, a nitrogen-containing heterocyclic group, a phosphino group, a hydroxyl group, a thiol group, and a hydrocarbyloxysilyl group.

11. The composition of claim 9, wherein the polymer (A) has a partial structure derived from at least one selected from the group consisting of a compound of formula (9), a compound of formula (10), a compound of formula (11), and a compound of formula (12): 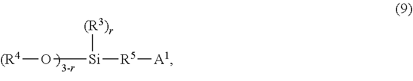
wherein A¹ is a monovalent functional group having at least one atom selected from the group consisting of N, P, O, S, and Si, and bonding to R⁵ through the N, P, O, S, Si, or a carbon atom in a carbonyl group, or a (thio)epoxy group, R³ and R⁴ are each independently a hydrocarbyl group, and R⁵ is a hydrocarbylene group, and r is 0, 1, or 2; 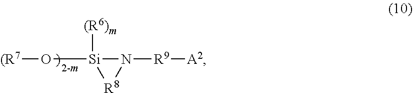
wherein A² is a monovalent functional group having at least one atom selected from the group consisting of N, P, O, S, and Si, having no active hydrogen, and bonding to R⁹ through the N, P, O, S, Si, or a hydrocarbyl group having 1 to 20 carbon atoms, R⁶ and R⁷ are each independently a hydrocarbyl group, R⁸ is a hydrocarbylene group, R⁹ is a single bond or a hydrocarbylene group, and m is 0 or 1; 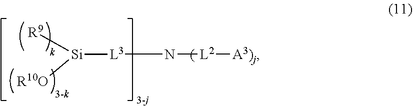
wherein A³ represents a monovalent group bonding to L² through an imino group, an amido group, a(thio)carbonyl group, a (thio)carbonyloxy group, a sulfide group, or a polysulfide group, or a protected primary amino group, a protected secondary amino group, a tertiary amino group, a nitrile group, a pyridyl group, a (thio)epoxy group, a (thio)isocyanate group, a (thio)formyl group, a (thio)carboxylic acid ester group, a metal salt of (thio)carboxylic acid ester group, —COX¹ with X¹ being a halogen atom, an imidazolyl group, or a group of formula (11a), L² and L³ are each independently a single bond or a hydrocarbylene group having 1 to 20 carbon atoms, R⁹ and R¹⁰ are each independently a hydrocarbyl group, k is independently 0, 1, or 2, and j is 0 or 1; 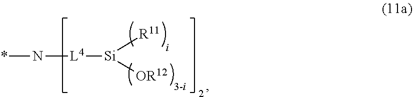
wherein L⁴ is independently a single bond or a hydrocarbylene group having 1 to 20 carbon atoms, R¹¹ and R¹² are each independently a hydrocarbyl group, i is independently 0, 1, 2, or 3, “*” is a site that binds to L²; and 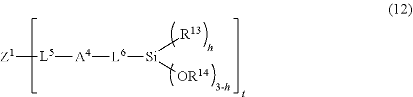
wherein A⁴ is independently an imino group, an amido group, a (thio)carbonyl group or a (thio)carbonyloxy group, Z¹ is a t-valent group having or not having a nitrogen atom and having 1 to 20 carbon atoms, L⁵ is independently a single bond or a hydrocarbylene group having 1 to 20 carbon atoms, L⁶ is independently a hydrocarbylene group having 1 to 20 carbon atoms, and R¹³ and R¹⁴ are each independently a hydrocarbyl group; h is independently 0 or 1, and t is 2 or 3.

12. The composition of claim 9, wherein the paraffin wax (B) is present in a range of from 0.5 to 5 parts by mass with respect to 100 parts by mass of the rubber component comprising the polymer (A) in the polymer composition.

13. The composition of claim 9, wherein the paraffin wax (B) has a melting point of 140° C. or less.

14. The composition of claim 9, further comprising:
a cross-linking agent.

15. A cross-linked product, produced by using the polymer composition of claim 9.

16. A tire, comprising:
a tread and/or a sidewall, formed from the polymer composition of claim 9.
